(19) United States
(12) Patent Application Publication
(10) Pub. No.: US 2019/0171443 A1
(43) Pub. Date: Jun. 6, 2019

(54) Method of Updating Application and Recording Medium

(71) Applicant: Konica Minolta, Inc., Tokyo (JP)

(72) Inventor: Shunsuke NAGAE, Amagasaki-shi (JP)

(73) Assignee: Konica Minolta, Inc., Tokyo (JP)

(21) Appl. No.: 16/207,504

(22) Filed: Dec. 3, 2018

(30) Foreign Application Priority Data
Dec. 5, 2017 (JP) 2017-233505

(51) Int. Cl. G06F 8/656; G06F 9/455

(52) U.S. Cl. CPC G06F 8/656; G06F 2009/45575; G06F 9/45558

(57) ABSTRACT

A computer-implemented method comprises creating, by an update management container, a second container in an information processing apparatus. The information processing apparatus accommodates two or more containers to provide a virtual environment in which a user process runs. The second container is different from a first container in which a first application is installed. The method further comprises: installing, by the update management container, an updated version of the first application in the second container; verifying, by the update management container, operation of the updated first application in the second container; and notifying, by the update management container, an address management container of change of an address corresponding to the first application after verifying operation of the updated first application, the address management container managing respective addresses of the two or more containers.

Japanese Patent Application No. 2017-233505 filed on Dec. 5, 2017, including description, claims, drawings, and abstract the entire disclosure is incorporated herein by reference in its entirely.

### BACKGROUND

### Technological Field

The present disclosure relates to a method of updating an application and more specifically to a method of updating an application installed in a container that provides a virtual environment in which a process runs.

### Description of the Related Art

Conventionally, provision of services utilizing virtual machines has been contemplated. For example, Japanese Laid-Open Patent Publication No. 2012-252704 discloses updating a system alternately through two virtual machine templates.

### SUMMARY

The updating of a system described in Japanese Laid-Open Patent Publication No. 2012-252704 includes setting the first virtual machine template in a power-off state and thereafter setting the second virtual machine template in a power-on state. This may prevent users from using a service provided by the virtual machine for a long time.

There is a demand for techniques for reducing the time in which services provided by virtual machines are unavailable to users.

To achieve at least one of the abovementioned objects, according to an aspect of the present invention, a computer-implemented method is provided. The method comprises creating, by an update management container, a second container in an information processing apparatus. The information processing apparatus accommodates two or more containers to provide a virtual environment in which a user process runs. The second container is different from a first container in which a first application is installed. The method further comprises: installing, by the update management container, an updated version of the first application in the second container; verifying, by the update management container, operation of the updated first application in the second container; and notifying, by the update management container, an address management container of change of an address corresponding to the first application after verifying operation of the updated first application, the address management container managing respective addresses of the two or more containers. The change of the address is change from the address of the first container to the address of the second container.

According to another aspect of the present disclosure, a non-transitory computer-readable storage medium is provided, which stores a program configured to cause a processor of a computer to execute the method described above.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an overall configuration of a network system including an information processing apparatus.

FIG. 2 is a hardware block diagram of an information processing device 100.

FIG. 3 is a block diagram showing a layered functional configuration of a server unit 20.

FIG. 4 is a diagram for explaining a process overview of updating an application in server unit 20.

FIG. 5 is a diagram schematically showing a process flow in updating App A in server unit 20.

FIG. 6 is a process sequence executed in server unit 20 in updating App A.

FIG. 7 is a diagram showing a sequence for acquisition of a manual for an application by an update management container 110.

FIG. 8 is a diagram for explaining a situation in which a request is transferred.

FIG. 9 is a diagram showing a sequence of setting a switching mode in an old container.

FIG. 10 is a diagram schematically showing updating of update management container 110 in server unit 20.

FIG. 11 is a diagram showing a sequence of updating the update management container.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of a server containing a container that provides a virtual environment in which a user process runs will be described below with reference to the figures. In the following description, the same parts and components are denoted by the same reference signs. Their names and functions are also the same. A detailed description thereof will not be repeated.

[1. Configuration of Server]

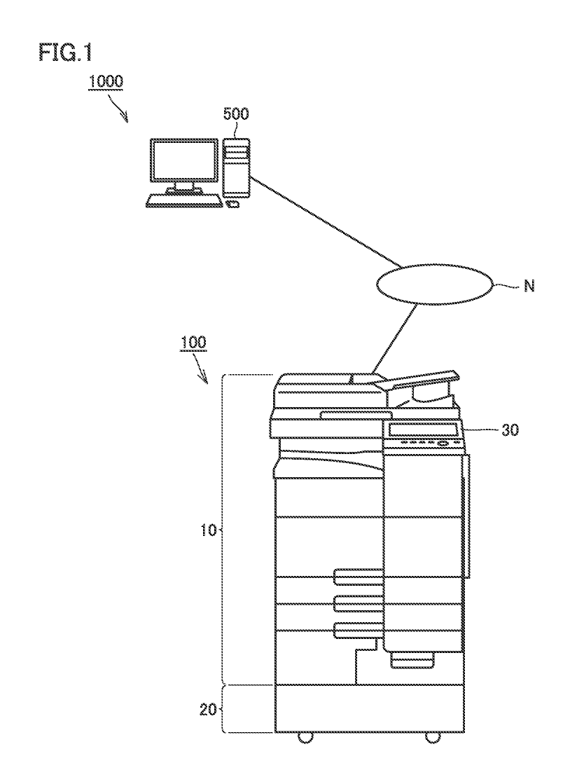

In the present embodiment, a server is configured as part of an information processing apparatus. FIG. 1 is a diagram showing an overall configuration of a network system including an information processing apparatus.

As shown in FIG. 1, in a network system 1000, an information processing device 100 communicates with a terminal 500 through a network N. Network N may be a LAN (Local Area Network) or may be a global network. Terminal 500 is, for example, a personal computer, a smartphone, or a tablet terminal.

By way of example, information processing device 100 is implemented as a device in which a server and an MFP (Multi-Functional Peripheral: image forming apparatus) are configured integrally such that their respective housings are coupled to each other. Information processing device 100 includes a printer unit 10, a server unit 20, and an operation panel 30. Operation panel 30 is used as a user interface of printer unit 10 and server unit 20.

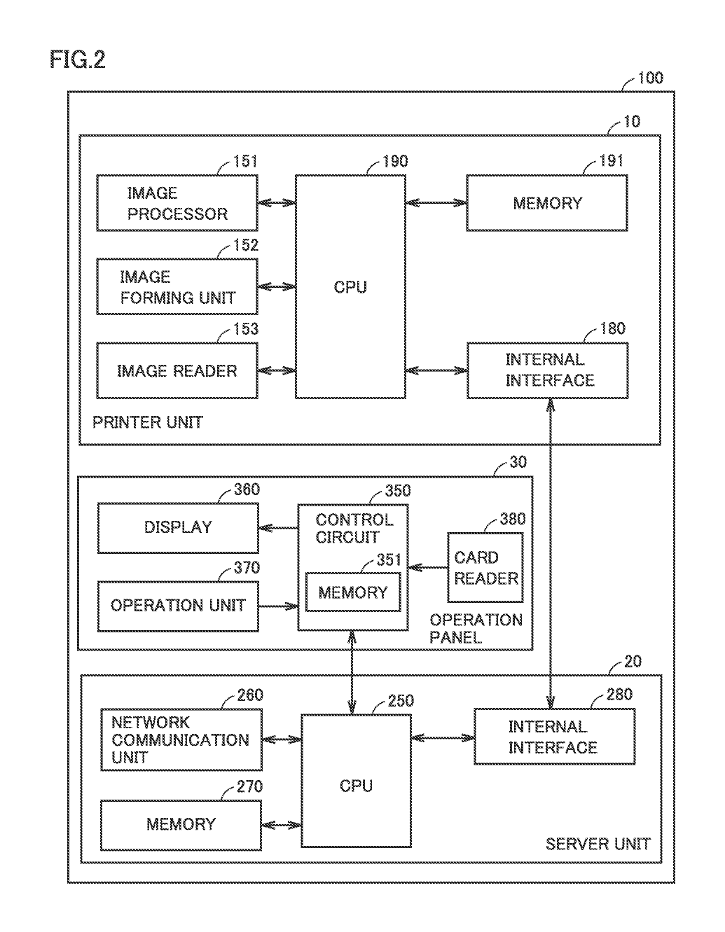

FIG. 2 is a hardware block diagram of information processing device 100. The configuration of each of printer unit 10 and server unit 20 will be described below.

(Printer Unit 10)

Printer unit 10 includes a CPU (Central Processing Unit) 190 for controlling the entire printer unit 10 and a memory 191. Memory 191 is implemented, for example, by a nonvolatile memory. Information stored in memory 191 may include a program executed by CPU 190 and data used in execution of the program.

Printer unit 10 further includes an image processor 151, an image former 152, an image reader 153, and an internal interface 180. Image processor 151 processes input image data to, for example, perform the processing such as enlargement and reduction of an output image. Image processor 151 is implemented by, for example, a processor for image processing and a memory. Image former 152 is implemented by hardware resources for forming an image on a recording sheet, such as toner cartridges, paper trays for accommodating recording sheets, and photoconductors, and hardware resources for conveying recording sheets. Image reader 153 is implemented by hardware resources configured to create image data of originals, such as a scanner. The functions of image processor 151, image former 152, and image reader 153 are well known in image forming apparatuses and a detailed description will not be repeated here.

Internal interface 180 functions as an interface of communication with server unit 20 and is implemented by, for example, a LAN (Local Area Network) card.

(Server Unit 20)

Server unit 20 includes a CPU 250 for controlling the entire server unit 20, a network communication unit 260, a memory 270, and an internal interface 280.

Network communication unit 260 is implemented by hardware resources configured to transmit/receive data to/from an external device such as terminal 500 through a global network. An example of the hardware resources is a network card. CPU 250 communicates with an external device through network communication unit 260.

Memory 270 is implemented, for example, by a nonvolatile memory. Information stored in memory 270 may include a program executed by CPU 250 and data used in execution of the program.

CPU 250 is further configured to control operation panel 30. Operation panel 30 includes a control circuit 350, a display 360 implemented by, for example, an organic electro luminescence (EL) display, an operation unit 370 implemented by, for example, a touch sensor, and a card reader 380 implemented by, for example, a contactless card reader.

Control circuit 350 controls the display operation of display 360 in accordance with a control signal from CPU 250. Operation unit 370 outputs input information to control circuit 350. Control circuit 350 outputs a signal in accordance with information input from operation unit 370 to CPU 250. Control circuit 350 transfers data read by card reader 380 to server unit 20 in accordance with a control signal from CPU 250.

[2. Functional Configuration of Server]

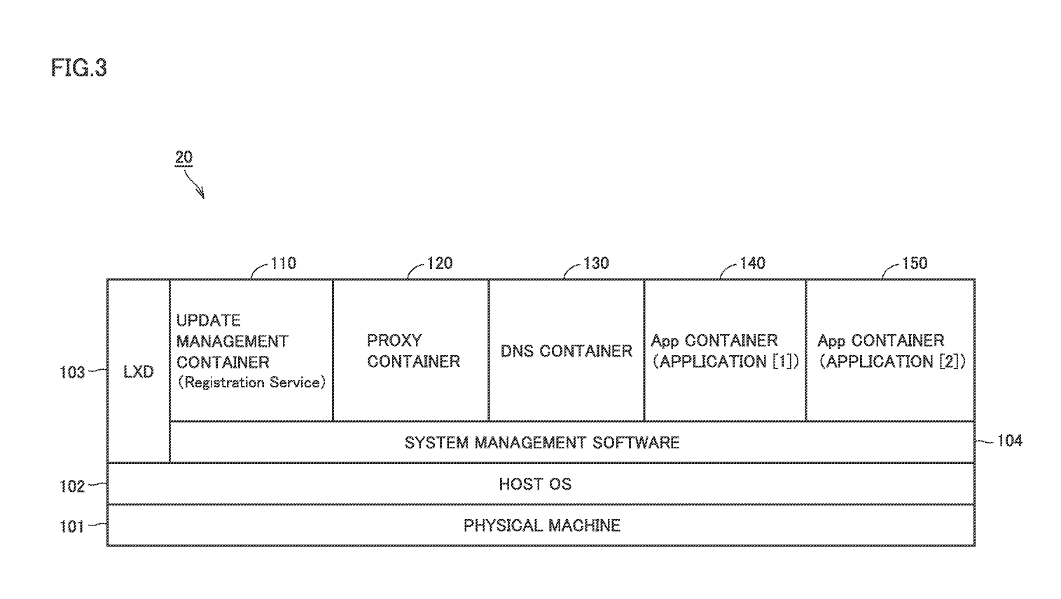

FIG. 3 is a block diagram showing a layered functional configuration of server unit 20. The functional configuration of server unit 20 is implemented, for example, by CPU 250 executing any given program.

As shown in FIG. 3, server unit 20 functions as, for example, a Linux (registered trademark) server. Server unit 20 has a host OS (operating system) 102 running on a physical machine 101 and system management software 104 running on host OS 102. Physical machine 101 is implemented by, for example, CPU 250 and memory 270. Each user process running on host OS 102 is confined in a container corresponding to the user process. System management software 104 is an example of control programs for container management. A typical control program for container management is DOCKER (registered trademark).

The inside of host OS 102 is divided into a “kernel space” for managing physical resources and a “user space” for executing user processes. In container virtualization, the user space is divided into a plurality of spaces, and resources that can be seen from each user process are limited. In this manner, a user space in which a single user process or a set of several user processes is confined is called “container”.

In an example, in container virtualization, all the processes run directly on host OS 102 installed in server unit 20. Since the processes in a container are put in an isolated space like an actual container for cargo shipping, the inside of one container cannot be seen from the inside of another container. This isolated space is created by the function of the kernel of the host OS. The computer resources usable through the host OS are isolated for each container to produce a space independent of the processes running directly on the host OS and other containers, whereby the resources are divided, distributed, and restricted. The container can start very quickly, almost as fast as the starting of usual processes, because the process merely starts as viewed from the OS. In another example, in container virtualization, the processes in each container may run on the OS in the container.

In server unit 20, LXD (Linux Container Daemon) 103 provides a management screen for the administrator to carry out the overall settings of the system using applications. A variety of settings such as adding/deleting a user account can be performed on the management screen. LXD 103 creates a container and deletes a container in server unit 20. LXD 103 further provides the function of centrally managing and viewing log information as to whether a container is created/deleted properly, in addition to resource information such as CPU utilization, memory utilization, and the number of started containers in server unit 20. This facilitates system management operations and trouble analysis in the event of failures. LXD 103 is an example of the system manager.

FIG. 3 shows five containers (an update management container 110, a proxy container 120, a DNS container 130, an App container 140, an App container 150) on system management software 104. Update management container 110, proxy container 120, DNS container 130, App container 140, and App container 150 each provide a service using an application. Server unit 20 may provide a service of each individual container or may provide a service by coordinating two or more containers with each other.

Update management container 110 manages an update to the application installed in each container in server unit 20. The service provided by update management container 110 is called Registration Service.

Proxy container 120 converts a request to each container in server unit 20 into the address of the container. Proxy container 120 is implemented, for example, by CPU 250 executing a Web server application such as Nginx (registered trademark).

DNS (Domain Name Service) container 130 converts a request to each container into the address of the container, in response to a request from proxy container 120.

Proxy container 120 and DNS container 130 manage the addresses of the containers in server unit 20. Proxy container 120 and DNS container 130 are thus examples of the address management container.

In each of App container 140 and App container 150, an application for providing a service to users is installed. In FIG. 3, the applications installed in App container 140 and App container 150 are denoted as “application [1]” and “application [2]”, respectively, for the purpose of distinguishing the kinds of applications from each other. The number of App containers included in server unit 20 is not limited to “2” as illustrated in FIG. 3.

[3. Process Overview of Updating Application]

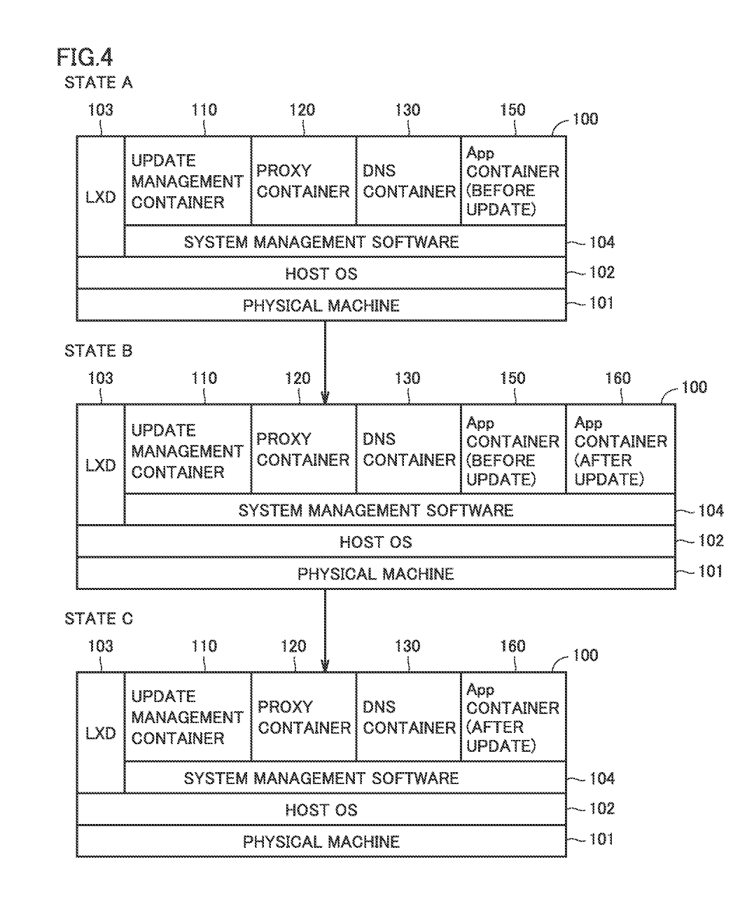

FIG. 4 is a diagram for explaining a process overview of updating an application in server unit 20. FIG. 4 shows three states A to C. In state A, “App container 150” is illustrated as an App container. The process overview of updating the application installed in App container 150 will be described below with reference to FIG. 4.

Upon detecting an update to the application (named “App A”) installed in App container 150, update management container 110 creates a new container (App container 160) as illustrated as state B. Update management container 110 detects an update to the application, for example, from a notice from an external device (the server that manages “App A”).

Update management container 110 installs the updated App A into App container 160 and verifies the operation of the updated App A. Upon verifying that the updated App A runs properly, update management container 110 notifies proxy container 120 and DNS container 130 that the address of App A has been changed from the address of App container 150 to the address of App container 160. Then, proxy container 120 and DNS container 130 each change the correspondence between the application stored in the inside thereof and the address of the container. The container providing the service of App A is changed from App container 150 to App container 160.

Subsequently, update management container 110 deletes App container 150, as illustrated as state C.

In server unit 20, update management container 110 manages the creation of App container 160 and the switching of the connection destination of the service of App A (changing the address setting in proxy container 120 and DNS container 130). Thus, even when server unit 20 is arranged on the premises of a customer, the creation of a container and the switching of the connection destination are carried out easily and inexpensively.

In server unit 20, after the notice of the update to App A is given, App container 150 in which App A before the update is installed provides a service until proper operation of App container 160 in which the updated App A is installed is verified. This can reduce the time in which the service of App A is unavailable to users.

[4. Process Flow in Updating Application]

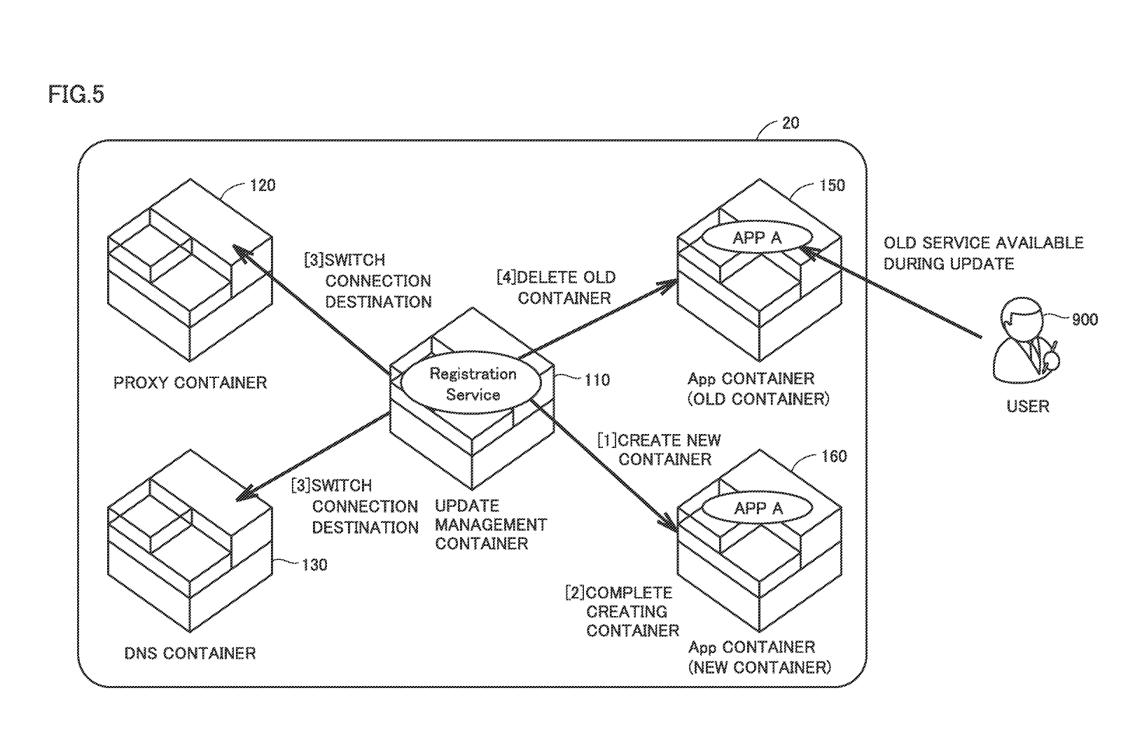

FIG. 5 is a diagram schematically showing a process flow in updating App A in server unit 20. The process flow in updating App A will be described in four stages ([1] to [4]) shown in FIG. 5.

Stage [1] (Create New Container) is the stage in which update management container 110 creates App container 160. In stage [1], the service of App A is provided from App container 150 to user 900. In this description, the processing by “user 900” means the processing by the terminal operated by user 900.

Stage [2] (Complete Creating Container) is the stage in which update management container 110 has completed creating App container 160.

Stage [3] (Switch Connection Destination) is the stage in which update management container 110 notifies proxy container 120 and DNS container 130 to change the address of App A from the address of App container 150 to the address of App container 160 after verifying proper operation of App A installed in App container 160.

Stage [4] (Delete Old Container) is the stage in which update management container 110 deletes App container 150 from server unit 20. Since proxy container 120 and DNS container 130 have changed the address corresponding to App A from the address of App container 150 to the address of App container 160 in stage [3], in stage [4], the service of App A is provided to user 900 from App container 160.

[5. Process Sequence in Updating Application]

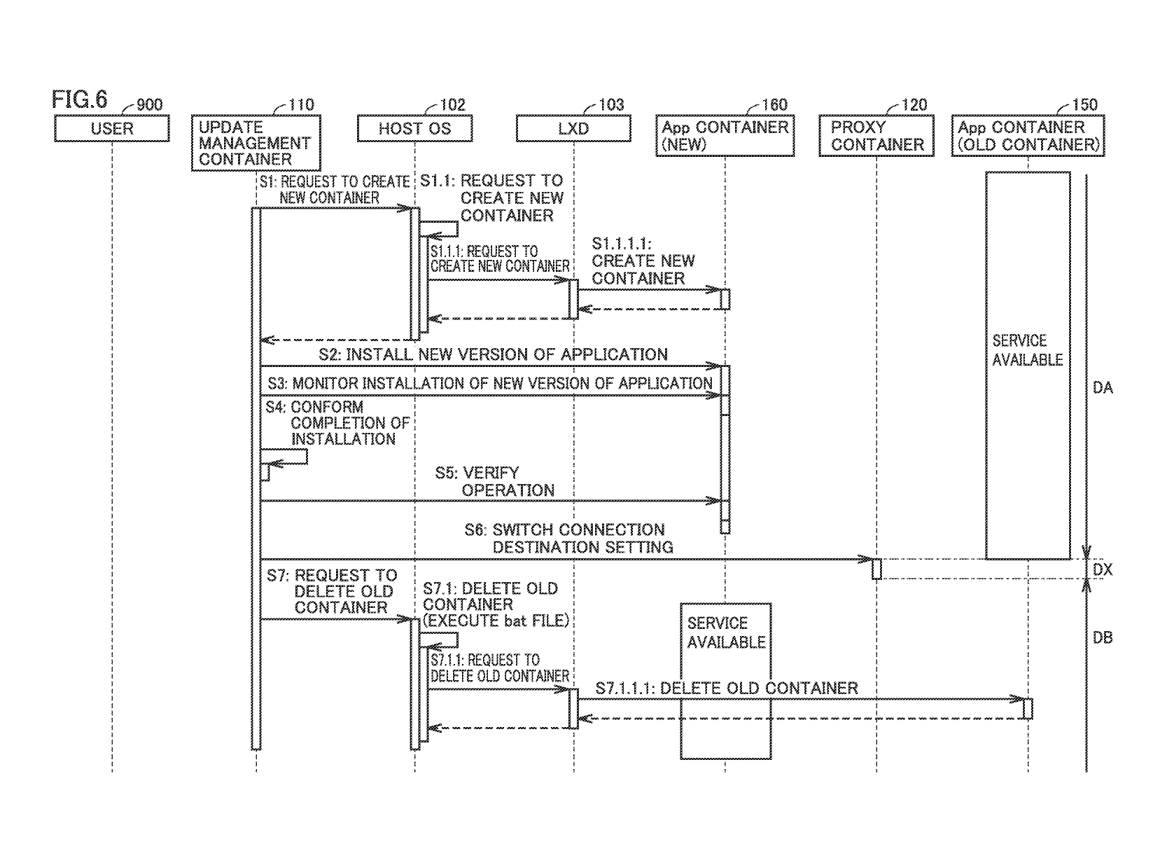

FIG. 6 is a process sequence executed in server unit 20 in updating App A. The process sequence is described using the reference signs, such as “S1” in FIG. 6.

Upon receiving a notice of an update to App A, at step S1, update management container 110 requests host OS 102 to create a new container. Host OS 102 receives the request from update management container 110 at step S1.1 and requests LXD 103 to create a new container at step S1.1.1.

At step S1.1.1.1, LXD 103 creates a new container (App container 160) on host OS 102, as illustrated in FIG. 4 and the like. Upon completion of creating App container 160, LXD 103 notifies host OS 102 of the completion. Host OS 102 receives the notice from LXD 103 and notifies update management container 110 of the completion of creating App container 160.

At step S2, update management container 110 starts installing the updated (new version) App A in App container 160. At step S3, update management container 110 monitors the progress of the installation. Step S4 indicates the timing when update management container 110 confirms the completion of installing the updated App A.

At step S5, update management container 110 verifies whether the updated App A runs properly. For example, update management container 110 transmits a predetermined request to App container 160 and determines that the updated App A runs properly on condition that a predetermined response is received from App container 160.

If it is determined that the updated App A runs properly, at step S6, update management container 110 requests proxy container 120 (and DNS container 130) to switch the setting of the address (connection destination) corresponding to App A. Proxy container 120 (and DNS container 130) switches the setting in response to the request. The setting is switched in proxy container 120 (and DNS container 130), whereby the provider of the service of App A is switched from App container 150 to App container 160.

At step S7, update management container 110 requests host OS 102 to delete App container 150. In response to the request from update management container 110, at step S7.1, host OS 102 requests LXD 103 to delete App container 150. The request is implemented, for example, by execution of a batch file (bat file). In response to the request from host OS 102, at step S7.1.1.1, LXD 103 deletes App container 150.

In FIG. 6, period DA is a period of time in which App container 150 provides the service of App A (before update). Period DB is a period of time in which App container 160 provides the service of App A (after update). Period DX is a period of time from when update management container 110 requests proxy container 120 (and DNS container 130) to switch the setting to when switching of the setting is completed in proxy container 120 (and DNS container 130).

As shown in FIG. 6, in server unit 20, the period of time in which the service of App A is not provided in updating of App A is denoted by period DX. On the other hand, if an application is updated in App container 150 in updating of App A, the period of time in which the service of App A is not provided includes not only period DX but also period DA. In server unit 20, App container 160 is created and the updated application is installed in App container 160, whereby the period of time in which the service of App A is not provided is reduced.

[6. Acquisition of Manual for Installation Monitoring]

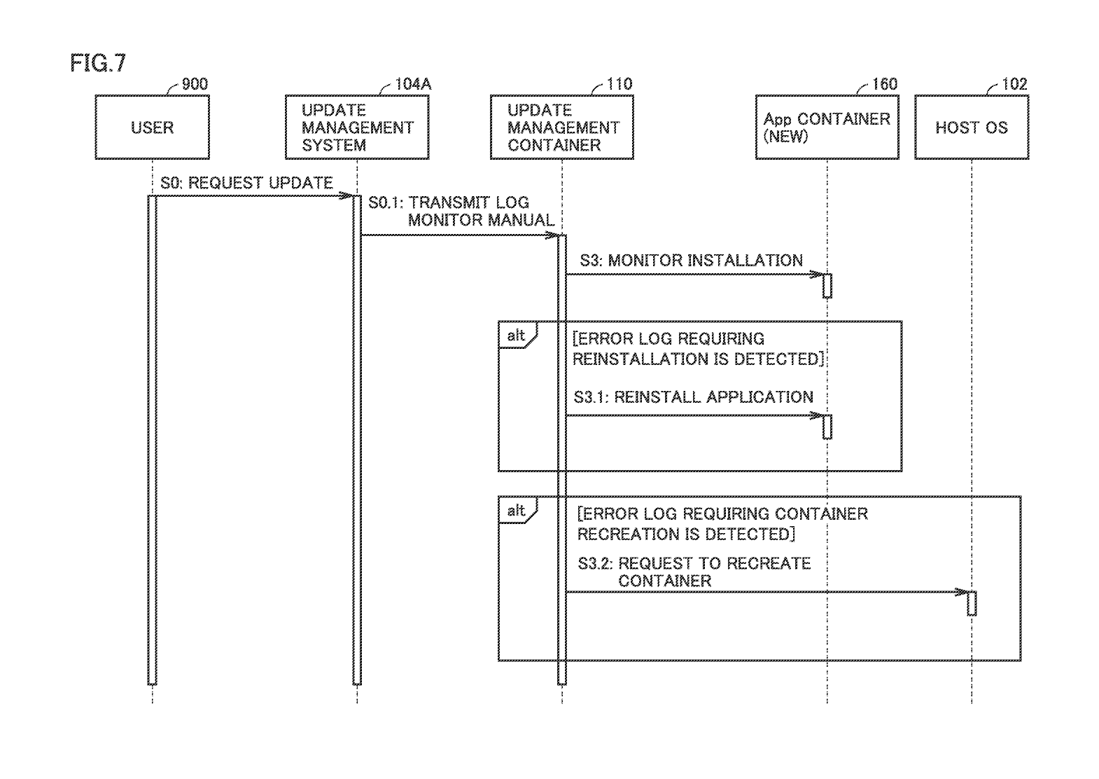

As explained in step S3 of FIG. 6, update management container 110 monitors the progress of installation of an application. Update management container 110 may acquire a manual in updating an application and monitor the progress of the installation in accordance with the manual FIG. 7 illustrates a sequence for acquiring a manual for an application by update management container 110. FIG. 7 shows only the part related to step S3 in the sequence in FIG. 6. The sequence is described using the reference signs, such as “S0” in FIG. 7.

In the example in FIG. 7, at step S0, user 900 requests update management system 104A to update App A in server unit 20. More specifically, user 900 transmits the request to update management system 104A, using a terminal. Update management system 104A may be disposed inside server unit 20 or outside server unit 20.

In response to the request at step S0, at step S0.1, update management system 104A transmits a log monitor manual to update management container 110. The log monitor manual is used for monitoring the progress of installation of App A. For example, the log monitor manual associates the log file related to installation with the installation status.

At step S3, update management container 110 monitors the progress of installation of the updated application in App container 160. In an example, update management container 110 requests a log related to installation from App container 160. App container 160 transmits a log file to update management container 110. Update management container 110 refers to the log monitor manual to specify the installation progress status, based on the log file received from App container 160.

If the specified progress status requires reinstallation, at step S3.1, update management container 110 reinstalls the updated application in App container 160.

If the specified progress status requires reconstruction of App container 160, at step S3.2, update management container 110 requests host OS 102 to create a new container. In response to the request at step S3.2, host OS 102 requests LXD 103 to create a new container, in the same manner as in step S1.1.1 (FIG. 6). Subsequently, LXD 103 creates a new container on host OS 102, in the same manner as in step S1.1.1.1 (FIG. 6).

If the specified progress status is that the installation of the updated application has been completed properly in App container 160, the control proceeds to step S4 and subsequent steps in FIG. 6.

As shown in FIG. 7, update management container 110 acquires a manual and manages the progress of installation in accordance with the manual to ensure detection of an error in installation of the application. In particular, in server unit 20, an OS different from host OS 102 resides in each of a plurality of containers. Therefore, a plurality of containers configure spaces different from each other. This may make it difficult for host OS 102 to detect an error in installation of an application in each container. In the example in FIG. 7, update management container 110 acquires the manual and manages the progress of installation, thereby ensuring detection of an error.

[7. Transfer of Request from Old Container to New Container]

In server unit 20, when installation of an application in a new container is completed, update management container 110 may instruct the container before update to transfer a request. This can avoid switching of the containers without processing a request to the container before update and causing interruption of the session between the user and the container before update.

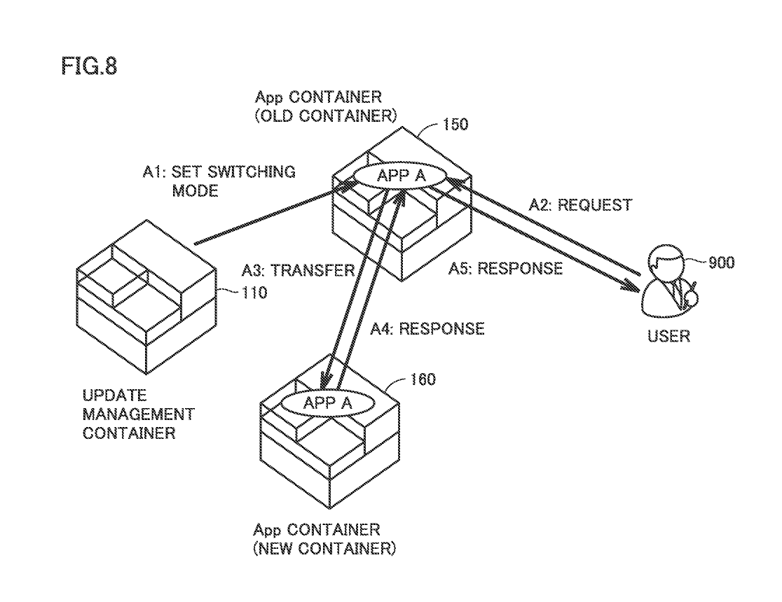

FIG. 8 is a diagram for explaining a situation in which a request is transferred. The processing related to transfer of a request is described using the reference signs, such as “A1” shown in FIG. 8.

In “A1: Set Switching Mode”, update management container 110 sets the old container (App container 150) to a switching mode, as denoted by “A1: Set Switching Mode”.

Subsequently, App container 150 receives a request from user 900, as denoted by “A2: New Request”, and then transfers the request to a new container (App container 160), as denoted by “A3: Transfer”.

App container 160 transmits a response to the transferred request to App container 150, as denoted by “A4: response”. App container 150 transmits the response from App container 160 to user 900, as denoted by “A5: response”.

If a request is not received from the user for a predetermined period after the switching mode is set, App container 150 notifies update management container 110 accordingly. Update management container 110 receives the notice from App container 150 and then requests proxy container 120 (and DNS container 130) to switch the setting of the address corresponding to the application (connection destination), as explained as step S6 in FIG. 6.

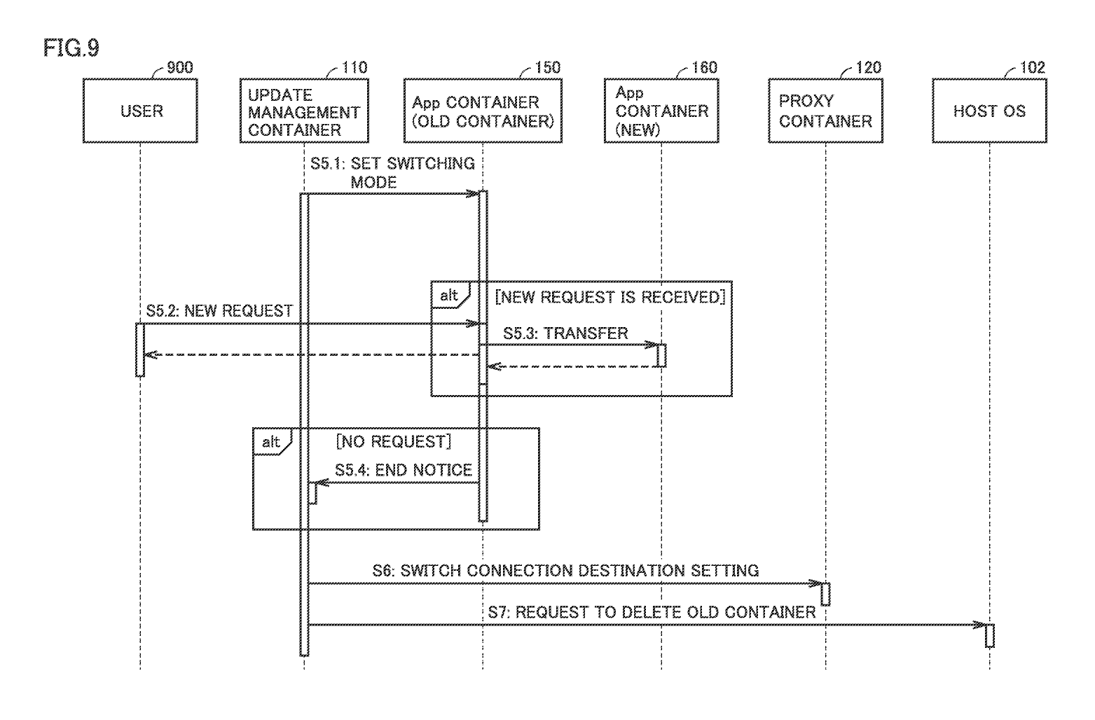

FIG. 9 is a diagram showing a sequence of setting the switching mode in the old container. FIG. 9 shows only the part related to step S6 in the sequence shown in FIG. 6. The sequence is described using the reference signs, such as “S5.1” shown in FIG. 9.

In the example in FIG. 9, update management container 110 executes step S5.1 after verifying that the updated App A runs properly at step S5 (FIG. 6). At step S5.1, update management container 110 instructs App container 150 to change to the switching mode.

Subsequently, upon receiving the request from user 900 at step S5.2, at step S5.3, App container 150 transfers the request to App container 160. Step S5.2 in FIG. 9 corresponds to “A2” in FIG. 8. Step S5.3 in FIG. 9 corresponds to “A3” in FIG. 8. App container 160 transmits a response to the request to App container 150. App container 150 transmits the response from App container 160 to user 900.

If no request from user 900 is received for a predetermined period after the switching mode is set, at step S5.4, App container 150 notifies update management container 110 accordingly. In FIG. 9, this notice is denoted as “end notice”.

Upon receiving “end notice” from App container 150, at step S6, update management container 110 requests proxy container 120 (and DNS container 130) to switch the setting of the address corresponding to the application (App A). At step S7, proxy container 120 (and DNS container 130) switches the setting of the address corresponding to App A.

[8. Updating of Update Management Container]

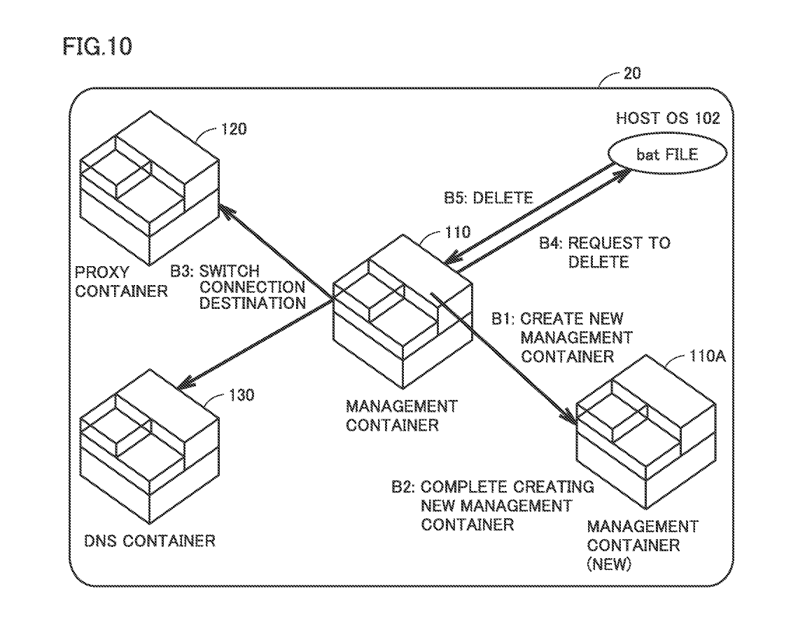

FIG. 10 is a diagram schematically showing updating of update management container 110 in server unit 20. The flow of updating update management container 110 is described using the reference signs, such as “B1” in FIG. 10.

Update management container 110 creates a new container when detecting that the update time for the application installed in update management container 110 has come, as denoted by “B1: Create New Management Container”, in the same manner as the updating of the application installed in another container. In FIG. 10, the newly created container is denoted as updated management container 110A.

When the creation of a new container has been completed as denoted by “B2: Complete Creating New Management Container”, update management container 110 installs the updated application in the new container. The installed application is an application for managing an update to the application in each container.

Subsequently, as denoted by “B3: Switch Connection Destination”, update management container 110 requests proxy container 120 (and DNS container 130) to switch the setting of the address corresponding to the update management container.

Subsequently, as denoted by “B4: Request to Delete”, update management container 110 requests host OS 102 to delete update management container 110. In response, as denoted by “B5: Delete”, update management container 110 is deleted. Subsequently, in server unit 20, an update to the application installed in each container is managed by update management container 110A.

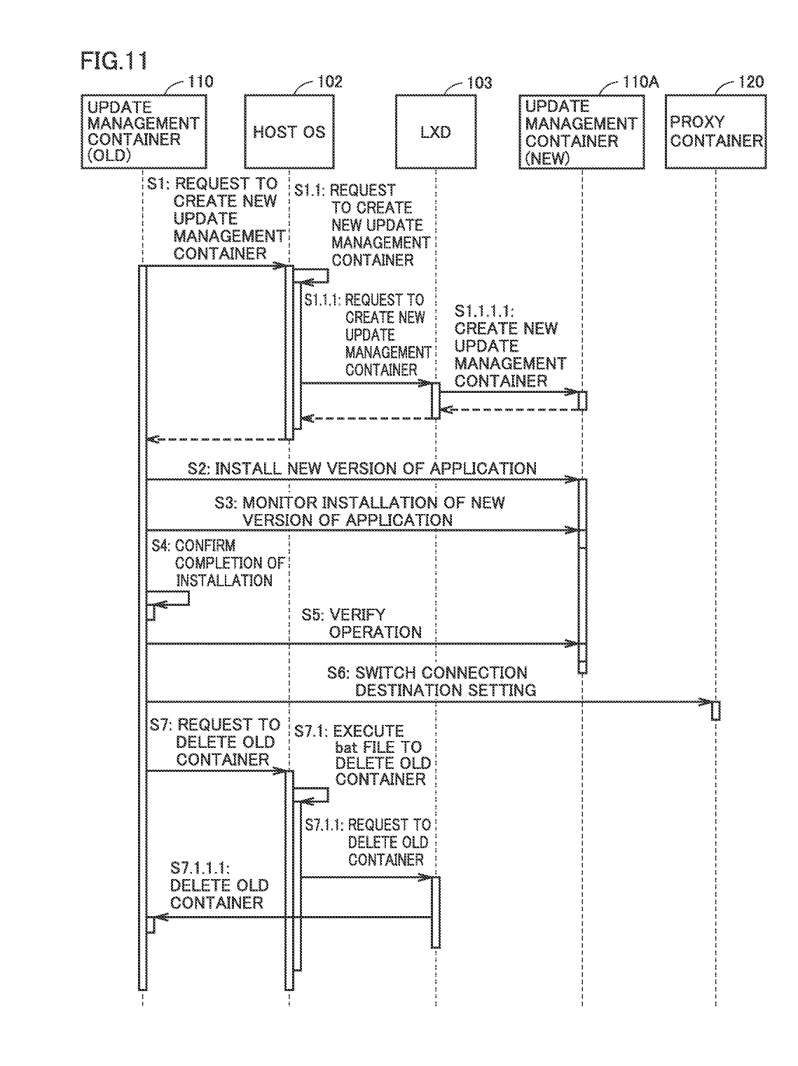

FIG. 11 is a diagram showing the sequence of updating the update management container. The sequence is described using the reference signs, such as “S1” in FIG. 11.

Upon receiving the notice of an update to the application installed in update management container 110, update management container 110 requests host OS 102 to create a new container, at step S1. Upon receiving the request from update management container 110 at step S1.1, host OS 102 requests LXD 103 to create a new container at step S1.1.1.

At step S1.1.1.1, LXD 103 creates a new container (update management container 110A) on host OS 102. Upon completion of creating update management container 110A, LXD 103 notifies host OS 102 of the completion. Upon receiving the notice from LXD 103, host OS 102 notifies update management container 110 of the completion of creating update management container 110A.

At step S2, update management container 110 starts installing the updated (new version) application in update management container 110A. At step S3, update management container 110 monitors the progress of the installation. Step S4 indicates the timing when update management container 110 confirms the completion of installing the updated application.

At step S5, update management container 110 verifies whether the updated application runs properly. For example, update management container 110 transmits a predetermined request to update management container 110A and determines that the updated application runs properly on condition that a predetermined response is received from update management container 110A.

If it is determined that the updated application runs properly, at step S6, update management container 110 requests proxy container 120 (and DNS container 130) to switch the setting of the address (connection destination) corresponding to the update management container. Proxy container 120 (and DNS container 130) switches the setting in response to the request. The setting is switched in proxy container 120 (and DNS container 130), whereby the provider of the service of the update management container is switched from update management container 110 to update management container 110A.

At step S7, update management container 110 requests host OS 102 to delete update management container 110. In response to the request from update management container 110, at step S7.1, host OS 102 requests LXD 103 to delete App container 150. The request is implemented, for example, by execution of a batch file (bat file). In response to the request from host OS 102, at step S7.1.1.1, LXD 103 deletes update management container 110.

Although embodiments of the present invention have been described and illustrated in detail, it is clearly understood that the same is by way of illustration and example only and not limitation, the scope of the present invention should be interpreted by terms of the appended claims.

What is claimed is:

1. A computer-implemented method comprising:
creating, by an update management container, a second container in an information processing apparatus, the information processing apparatus accommodating two or more containers to provide a virtual environment in which a user process runs, and the second container being different from a first container in which a first application is installed;
installing, by the update management container, an updated version of the first application in the second container;
verifying, by the update management container, operation of the updated first application in the second container; and
notifying, by the update management container, an address management container of change of an address corresponding to the first application after verifying operation of the updated first application, the address management container managing respective addresses of the two or more containers,
wherein the change of the address is change from the address of the first container to the address of the second container.

2. The method according to claim 1, wherein
in the information processing apparatus, each of the two or more containers runs on a host OS (operating system),
a system manager is installed in the information processing apparatus to create or delete a container on the host OS, and
the creating by the update management container of the second container includes
requesting, by the update management container, the host OS to create a container,
requesting, by the host OS, the system manager to create a container in response to the request to create from the update management container, and
creating, by the system manager, the second container in response to the request to create from the host OS.

3. The method according to claim 2, further comprising:
requesting, by the update management container, the host OS to delete the first container after notifying the address management container of change of the address;
requesting, by the host OS, the system manager to delete the first container in response to the request to delete from the update management container; and
deleting, by the system manager, the first container in response to the request to delete from the host OS.

4. The method according to claim 1, further comprising acquiring, by the update management container, a manual of the updated first application,
wherein the update management container verifies operation of the updated first application in accordance with the manual.

5. The method according to claim 1, further comprising instructing, by the update management container, the first container to transfer a request from a user to the first application to the second container after verifying operation of the updated first application.

6. The method according to claim 1, wherein
the update management container is configured with the first container, and
the first application is an application for managing an update to an application installed in each container in the information processing apparatus.

7. The method according to claim 2, further comprising acquiring, by the update management container, a manual of the updated first application,
wherein the update management container verifies operation of the updated first application in accordance with the manual.

8. The method according to claim 2, further comprising instructing, by the update management container, the first container to transfer a request from a user to the first application to the second container after verifying operation of the updated first application.

9. The method according to claim 2, wherein
the update management container is configured with the first container, and
the first application is an application for managing an update to an application installed in each container in the information processing apparatus.

10. The method according to claim 3, further comprising acquiring, by the update management container, a manual of the updated first application,
wherein the update management container verifies operation of the updated first application in accordance with the manual.

11. The method according to claim 3, further comprising instructing, by the update management container, the first container to transfer a request from a user to the first application to the second container after verifying operation of the updated first application.

12. The method according to claim 3, wherein
the update management container is configured with the first container, and
the first application is an application for managing an update to an application installed in each container in the information processing apparatus.

13. The method according to claim 4, further comprising instructing, by the update management container, the first container to transfer a request from a user to the first application to the second container after verifying operation of the updated first application.

14. The method according to claim 4, wherein
the update management container is configured with the first container, and
the first application is an application for managing an update to an application installed in each container in the information processing apparatus.

15. The method according to claim 5, wherein
the update management container is configured with the first container, and
the first application is an application for managing an update to an application installed in each container in the information processing apparatus.

16. A non-transitory computer-readable storage medium storing a program configured to cause a processor of a computer to execute a method, die method comprising:
creating, by an update management container, a second container in the information processing apparatus, the update management container accommodating two or more containers to provide a virtual environment in which a user process runs, and the second container being different from a first container in which a first application is installed;
installing, by the update management container, an updated version of the first application in the second container;
verifying, by the update management container, operation of the updated first application in the second container; and
notifying, by the update management container, an address management container of change of an address corresponding to the first application after verifying operation of the updated first application, the address management container managing respective addresses of the two or more containers,
wherein the change of the address is change from the address of the first container to the address of the second container.
